(19) United States
(12) Patent Application Publication
(10) Pub. No.: US 2011/0068258 A1
(43) Pub. Date: Mar. 24, 2011

(54) NONROTATIONALLY SYMMETRIC LENS, IMAGING SYSTEM INCLUDING THE SAME, AND ASSOCIATED METHODS

(76) Inventors: Robert D. TeKOLSTE, Charlotte, NC (US); Alan D. Kathman, Charlotte, NC (US)

(21) Appl. No.: 12/886,312

(22) Filed: Sep. 20, 2010

Related U.S. Application Data
(60) Provisional application No. 61/272,387, filed on Sep. 18, 2009.

(51) Int. Cl. G02B 13/18; G02B 13/08; G06F 17/50

(52) U.S. Cl. 250/227.2; 359/668; 359/720; 700/103

(57) ABSTRACT

A singlet lens with opposing first and second surfaces has at least one surface being nonrotationally symmetric, the singlet lens substantially maintaining a ratio of magnification along orthogonal axes. The nonrotationally symmetric surface may be used in an imaging system, which may be used in a mobile handset.

### CROSS-REFERENCE TO RELATED APPLICATION

This application claims priority to pending U.S. Provisional Application No. 61/272,387, filed in the U.S. Patent and Trademark Office on Sep. 18, 2009, and entitled “NONROTATIONALLY SYMMETRIC LENS, IMAGING SYSTEM INCLUDING THE SAME, AND ASSOCIATED METHODS,” which is incorporated by reference herein in its entirety and for all purposes.

### BACKGROUND

Nearly all refractive lenses, especially refractive lenses used in imaging, are made either by polishing or diamond turning/molding. All of these methods have traditionally yielded rotationally symmetric shapes. Nonrotationally symmetric shapes are sometimes realized by taking a section of a rotationally symmetric lens off-axis, but the basic shape is still a section of a rotationally symmetric shape. Optical correctors having a nonrotationally symmetric surface and decentered systems have been employed in systems to compensate for nonrotationally symmetric aberrations or as anamorphic lenses, but refractive lenses employing a nonrotationally symmetric surface have not been.

### SUMMARY

Embodiments are therefore directed to nonrotationally symmetric lens surfaces, imaging systems including the same, a mobile communication system including the same, and associated methods.

Embodiments may be directed to a singlet lens having opposing first and second surfaces, at least one surface being nonrotationally symmetric, the singlet lens substantially maintaining a ratio of magnification along orthogonal axes.

Both first and second surfaces may be nonrotationally symmetric. The nonrotationally symmetric surface may be an xy polynomial or a Zernike polynomial.

Embodiments may be directed to an imaging system, including a first optical surface adjacent an input plane, a detector, and a second optical surface between the first optical surface and the detector, the second optical surface being non-rotationally symmetric, wherein the first optical surface, the detector, and the second optical surface are linearly arranged.

The second optical surface may be a closest optical surface to the detector. The imaging system as may include a third optical surface between the first optical surface and the second optical surface, the third optical surface being non-rotationally symmetric. The third optical surface may be opposite the second optical surface on a substrate. At least two of the first optical surface, the detector, and the second optical surface may be secured on a wafer level before being singulated.

The detector may be a non-rotationally symmetric array of sensing elements and the second optical surface is optimized for the non-rotationally symmetric array. The non-rotationally symmetric array may be a rectangle. The second optical surface may be an xy polynomial or a Zernike polynomial.

The second optical surface may be spaced from an aperture stop of the imaging system. The second optical surface may serve as a vignetting aperture for the imaging system.

Embodiments may be directed to a mobile handset including an imaging system.

Embodiments may be directed to a method of creating a nonrotationally symmetric lens surface, including replacing a radial term in a conventional lens design with a nonrotationally symmetric polynomial, optimizing a nonrotationally symmetric lens design, and forming a plurality of nonrotationally symmetric lens surfaces on a wafer in accordance with the optimized nonrotationally symmetric lens design.

The nonrotationally symmetric polynomial is an XY polynomial or a Zernike polynomial. Forming may include replicating the plurality of nonrotationally symmetric lens surfaces on the wafer. Optimizing may include matching the nonrotationally symmetric lens design to a nonrotationally symmetric element in a system into which the nonrotationally symmetric lens surface is to be incorporated. Before separating the plurality of nonrotationlly symmetric lens surfaces from the wafer, the method may include securing a plurality of nonrotationally symmetric elements adjacent the nonrotationally symmetric lens surfaces. The plurality of nonrotationally symmetric elements may be on a common substrate while being secured to the plurality of nonrotationally symmetric lens surfaces. The nonrotationally symmetric lens surfaces may substantially maintain a ratio of magnification along orthogonal axes. The method may include forming a second lens surface on an opposite side of the wafer. Forming the second lens surface may include replacing a radial term in a second conventional lens design with a nonrotationally symmetric polynomial, optimizing a second nonrotationally symmetric lens design, and forming a plurality of second nonrotationally symmetric lens surfaces on the opposite side of the wafer in accordance with the optimized second nonrotationally symmetric lens design.

### BRIEF DESCRIPTION OF THE DRAWINGS

The above and other features and advantages will become more apparent to those of ordinary skill in the art by describing in exemplary embodiments with reference to the attached drawings, in which:

FIG. 1A illustrates a perspective view of a rotationally symmetric lens;

FIG. 1B illustrates a perspective view of a nonrotationally symmetric lens in accordance with an embodiment;

FIGS. 2A, 3A, 4A, 5A, and 6A illustrate plots of performance parameters for a rotationally symmetric lens of FIG. 1A;

FIGS. 2B, 3B, 4B, 5B, and 6B illustrate plots of performance parameters for a nonrotationally symmetric lens of FIG. 1B;

FIG. 7A illustrates a side schematic view of an imaging system including a rotationally symmetric lens;

FIG. 7B illustrates a side schematic view of an imaging system including a nonrotationally symmetric lens in accordance with an embodiment;

FIGS. 8A, 9A, and 10A illustrate plots of performance parameters for the imaging system of FIG. 7A;

FIGS. 8B, 9B, and 10B illustrate plots of performance parameters for the imaging system of FIG. 7B;

FIG. 11A illustrates a perspective view of a rotationally symmetric lens;

FIG. 11B illustrates a side view of a nonrotationally symmetric lens in accordance with an embodiment;

FIGS. 12A, 13A, and 14A illustrate plots of performance parameters for a rotationally symmetric lens of FIG. 11A;

FIGS. 12B, 13B, and 14B illustrate plots of performance parameters for a nonrotationally symmetric lens of FIG. 11B;

FIGS. 15A to 15C illustrate vignetting apertures in accordance with embodiments;

FIG. 16 illustrates a schematic plan view of an array of nonrotationally symmetric lenses in accordance with an embodiment;

FIG. 17 illustrates a schematic plan view of a wafer of nonrotationally symmetric lenses in accordance with an embodiment; and

FIG. 18 illustrates a block diagram of a mobile communication device incorporating a nonrotationally symmetric lens in accordance with embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Some barriers to using nonrotationally symmetric lenses include difficulty in fabrication and requiring a fixed angular orientation with respect to an image plane. However, replication may be used to realize such lenses. Additionally or alternatively, free-form machining allows realization of such design, as set forth, for example, in co-pending, commonly assigned Serial No. PCT/US09/057482, filed Sep. 18, 2009, claiming priority to U.S. Provisional Application No. 61/098,065, which is incorporated by reference herein for all purposes. Fast servo tooling and micromilling may also be employed to make free form shapes on a wafer at a microlevel. Such wafers may be used as molds for replication. Further, when nonrotationally symmetric lenses are integrated with other components on a wafer level, such orientation may be readily controlled.

In designing such lenses, conic sections may still be employed. The lens design may maximize the mtf in the image plane, i.e., in the used image area or a nonrotationally symmetric portion of the image plane. The use of the nonrotationally symmetric design allows more degrees of freedom than a traditional rotationally symmetric lens. Examples of a nonrotationally symmetric lens include an XY polynomial lens, a Zernike polynomial lens, a Müller polynomial lens, and so forth.

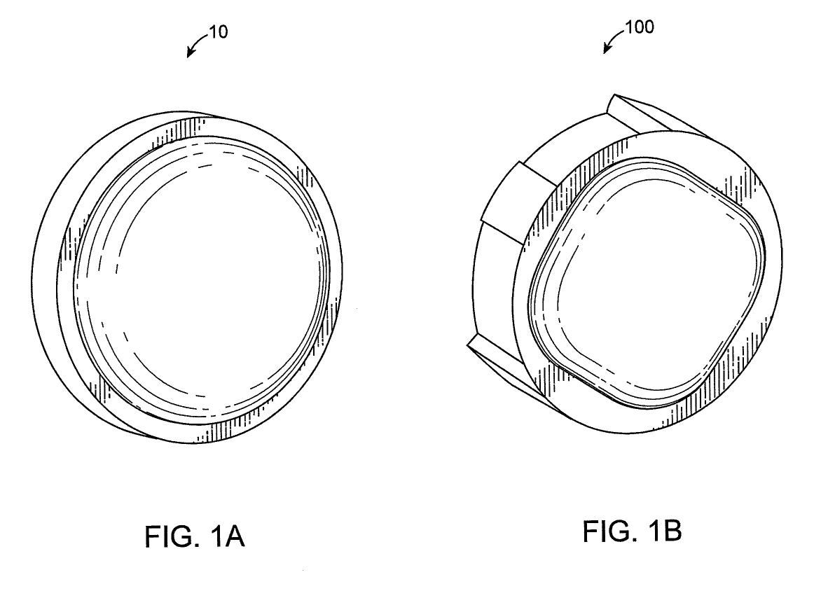

FIG. 1A illustrates a perspective view of a rotationally symmetric lens 10. FIG. 1B illustrates a perspective view of a nonrotationally symmetric lens 100. As may be seen therein, the nonrotationally symmetric lens 100 is not rotationally symmetric and provides more power towards edges thereof. Such a nonrotationally symmetric lens may be realized by substituting an xy polynomial, e.g., x²+y², for the r² term in a conventional rotationally symmetric design, having a nonrotationally symmetric footprint, here a rectangular, and then optimizing this design for these terms. Since this optimization does not result a rotationally symmetric lens, improved performance may be achieved using such a nonrotationally symmetric lens. Further, the design being optimized is not anamorphic, i.e., a ratio of magnification of orthogonal axes is substantially maintained upon traversing the nonrotationally symmetric surface.

One particular application of using nonrotationally symmetric lenses is in the design of a singlet lens. Singlet lenses are widely employed due to their low cost, but the performance thereof is compromised.

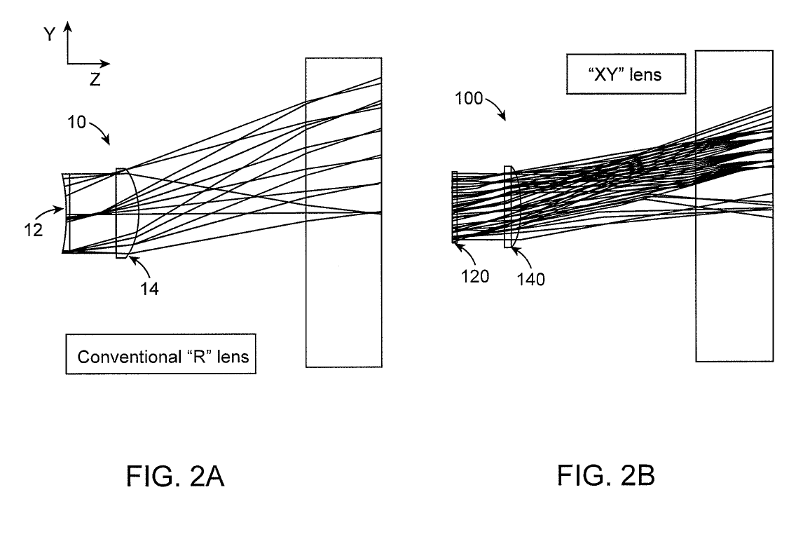

FIGS. 2A and 2B illustrate ray traces of light through the rotationally symmetric lens 10, the XY polynomial lens 100, and the Zemike polynomial lens 100′, respectively. In the particular example of a singlet illustrated in FIG. 2A, the rotationally symmetric lens 10 is a meniscus lens that includes a concave surface 12 and a convex surface 14. In the particular example of a singlet illustrated in FIG. 2B, the nonrotationally symmetric lens 100 is a meniscus lens that includes a concave surface 120 and a convex surface 140. The design parameters of these lenses are the same, other than the use of radial polynomials for the design of the rotationally symmetric lens 10 and the use of xy polynomials for the design of the nonrotationally symmetric lens 100.

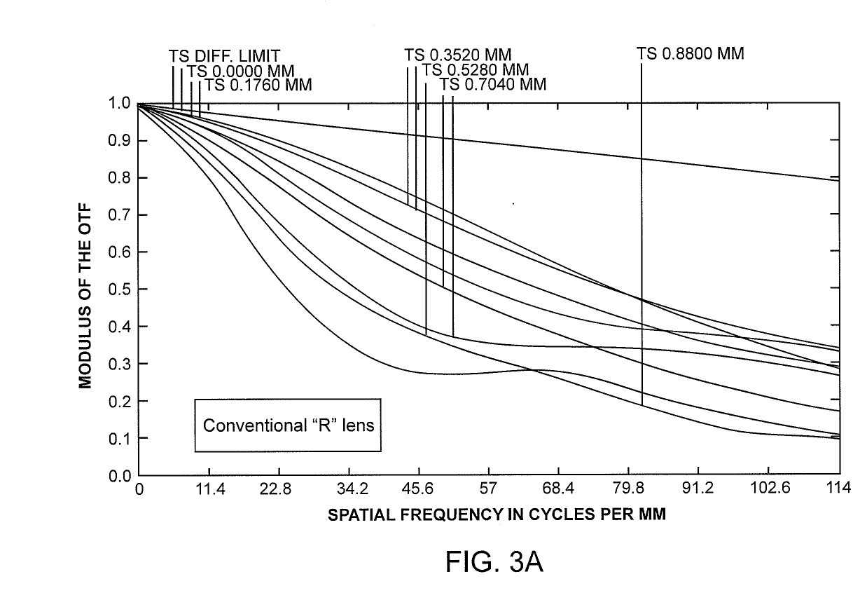

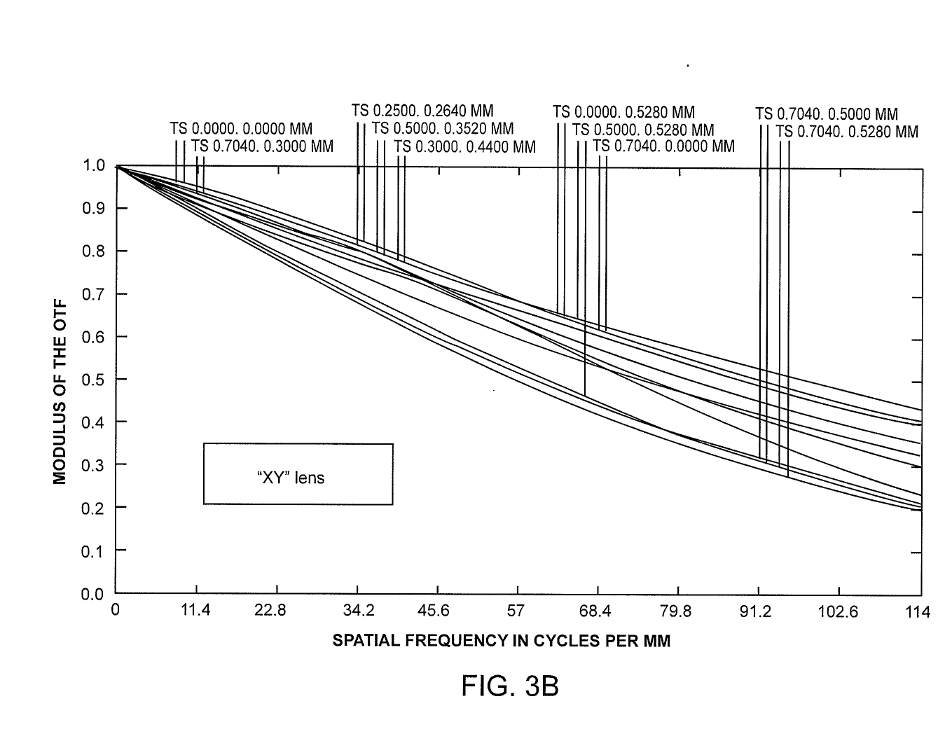

FIGS. 3A to 3B illustrate plots of the nominal modulus transfer function (mtf), i.e., contrast versus resolution, over a wavelength range of 0.435 to 0.64 μm, of the rotationally symmetric lens 10, the nonrotationally symmetric lens 100, and the nonrotationally symmetric lens 100′, respectively. As can be seen by comparing the plots in FIGS. 3A and 3B, the mtf of the nonrotationally symmetric lens 100 is higher and more consistent than the mtf of the rotationally symmetric lens 10.

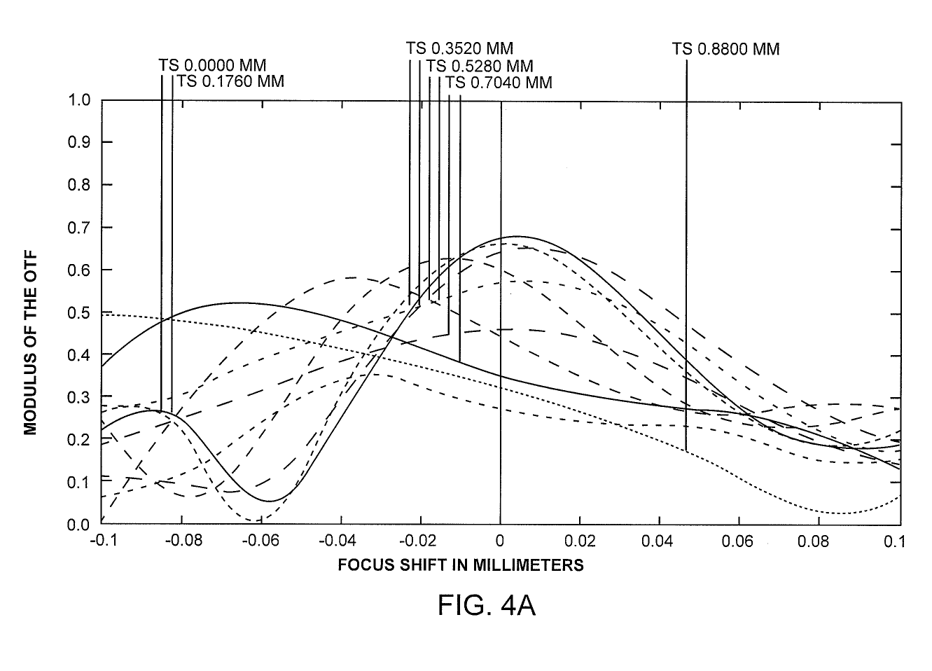

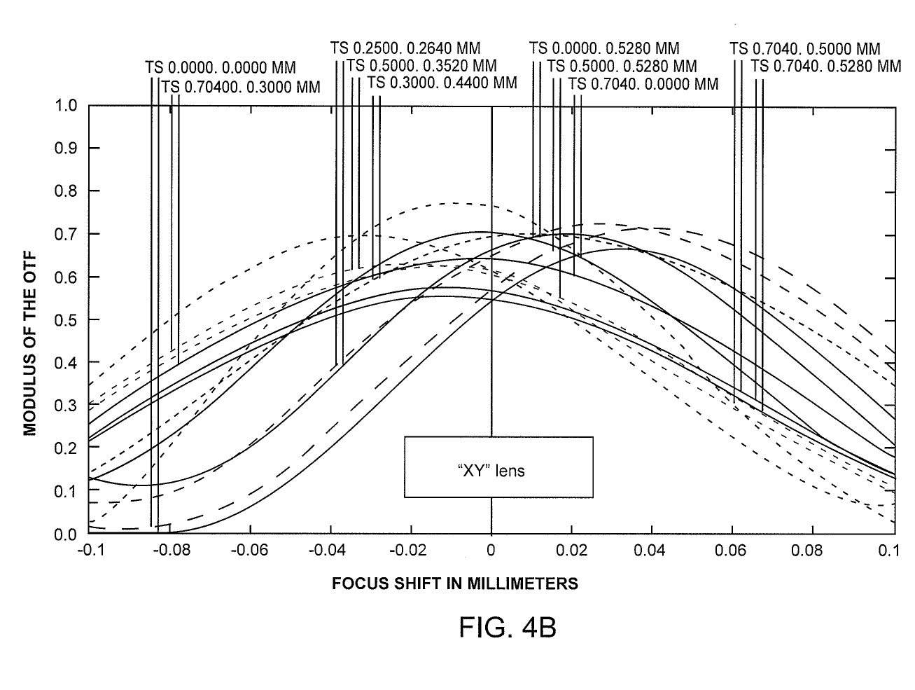

FIGS. 4A to 4B illustrate plots of the through focus mtf at 57 cycles/mm, i.e., contrast versus focus shift, over a wavelength range of 0.435 to 0.64 μm, of the rotationally symmetric lens 10, the XY polynomial lens 100, and the Zemike polynomial lens 100′, respectively. As can be seen by comparing the plots in FIGS. 4A and 4B, the through focus mtf of the XY polynomial lens 100 is higher and more consistent than the through focus mtf of the rotationally symmetric lens 10.

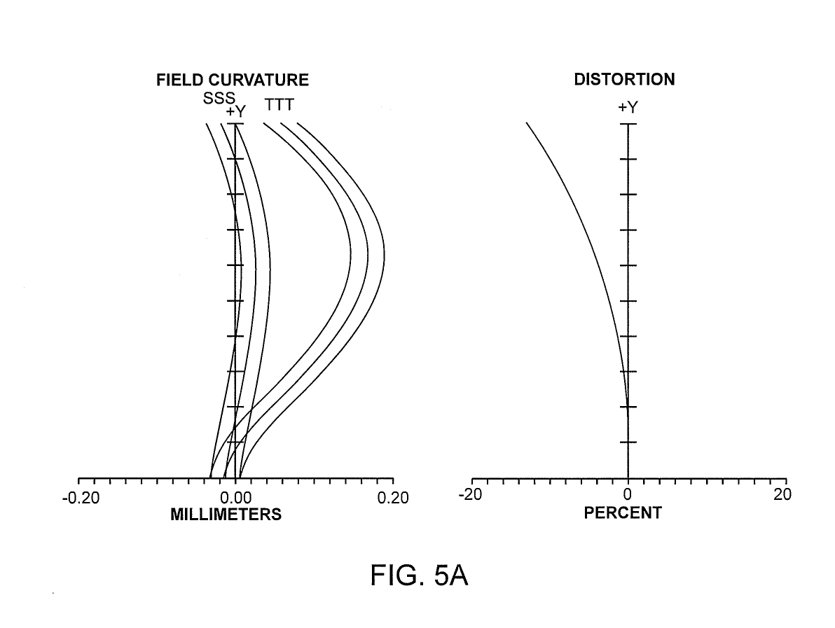

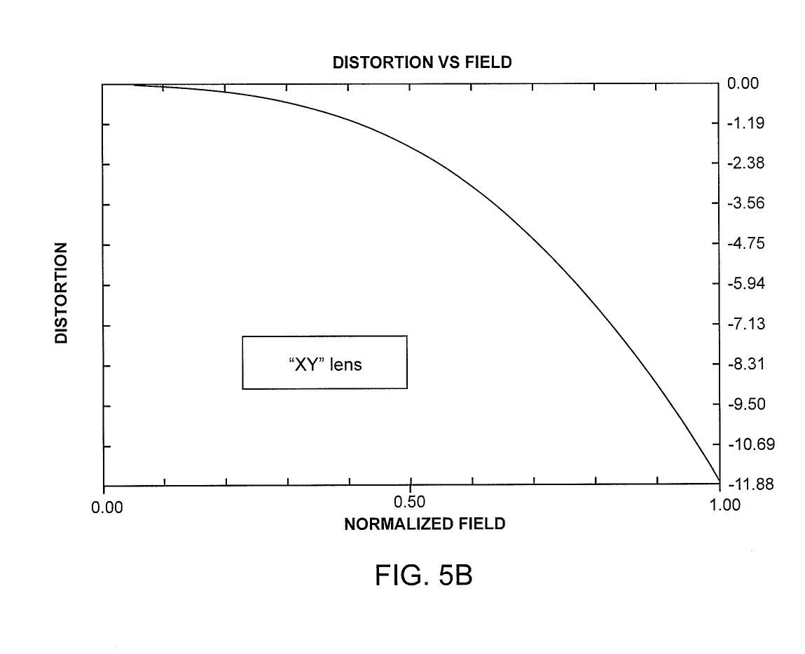

FIGS. 5A and 5B illustrate plots of distortion of the rotationally symmetric lens 10 and the nonrotationally symmetric lens 100, respectively. As can be seen therein, the distortion of the nonrotationally symmetric lens 100 is less than that of the rotationally symmetric lens 10.

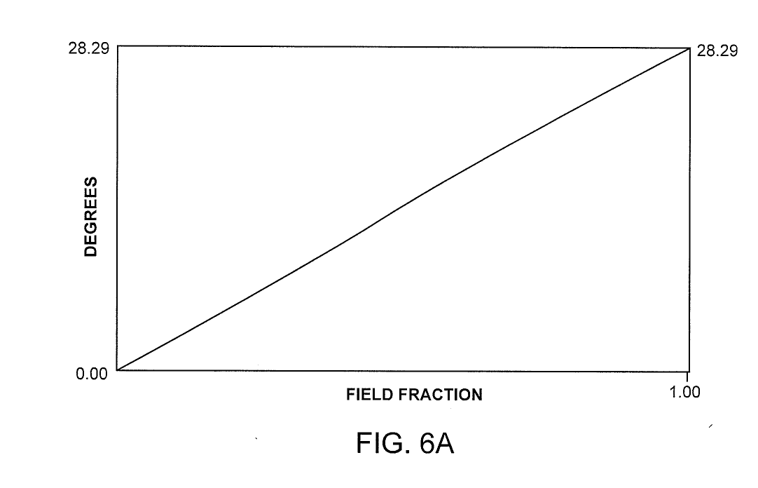

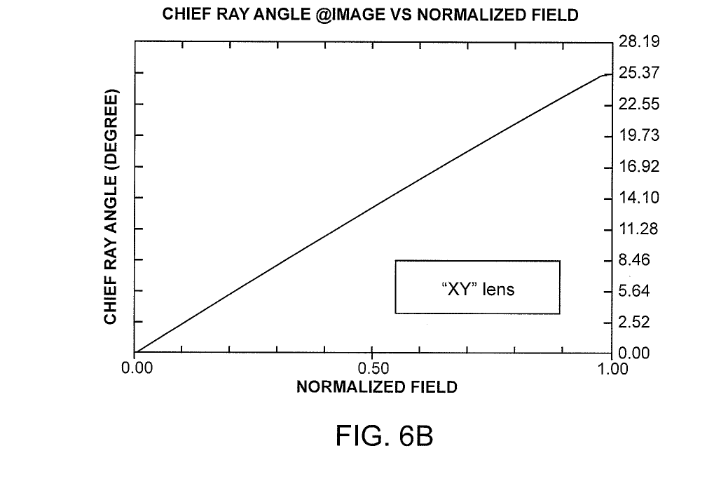

FIGS. 6A and 6B illustrate plots of the chief ray angle of the rotationally symmetric lens 10 and the nonrotationally symmetric lens 100, respectively. As can be seen therein, and as also evident from the ray traces in FIGS. 2A and 2B, the nonrotationally symmetric lens 100 has a smaller chief ray angle than the rotationally symmetric lens 10.

While the nonrotationally symmetric lens 100 illustrated above has opposing surfaces provided with nonrotationally symmetric surfaces, the above advantages may be realized by providing a nonrotationally symmetric surface on one of the surfaces of a singlet lens.

Another application of nonrotationally symmetric lenses is in imaging systems, e.g., a camera, in which optical performance may be realized by maximizing mtf on an image plane. Lenses near the aperture stop, which are pretty uniformly filled with rays coming from all field directions, are not as likely to benefit from generalized lens shapes. Field flatteners and corrector lenses, which reside further from the stop, where the fields are more resolved spatially, could potentially benefit more from having the extra degrees of freedom offered through use of nonrotationally symmetric lenses. Using such lenses in an imaging system may be particularly difficult, as many imaging systems adjust focus by rotating a lens, which would alter the alignment of the nonrotationally symmetric lenses.

Use of conventional rotationally symmetric with detectors, e.g., in cameras, results in lenses that perform as well in parts of the image plane that don't have any sensing unit present as in the parts that do. In other words, these conventional lenses are designed for the corners of the sensor and that performance is maintained at the corner radius all around the image plane, even though the sensing region is only present in a non-circular footprint, e.g., a 4:3 aspect ratio inscribed rectangle. Additionally, having a rotationally symmetric lens prescription complicates the effort to pack the lenses as closely as possible on a wafer.

In contrast, by using nonrotationally symmetric functions, e.g., xy polynomials,

Zenike polynomials, Müller polynomials, for lens designs, as discussed in detail below, rather than functions of r (radius), imaging characteristics and density of lenses may be improved. In particular, arbitrary shapes may be used to make better use of the used portion of the optical system, especially for imaging to non-rotationally symmetric image planes. Further, such lenses may be packed into a rectangular array, i.e., in accordance with the array of sensing elements. To study the impact on a camera design, the last two optical surfaces of a two element camera design were changed from r to xy polynomial designs. Everything else was held constant, and the system was re-optimized with fields distributed in a rectangular area corresponding to the image plane. Again, the failure of the optimization to remain at the symmetric solution indicates that improved performance may be realized with polynomials other than radially symmetric polynomials.

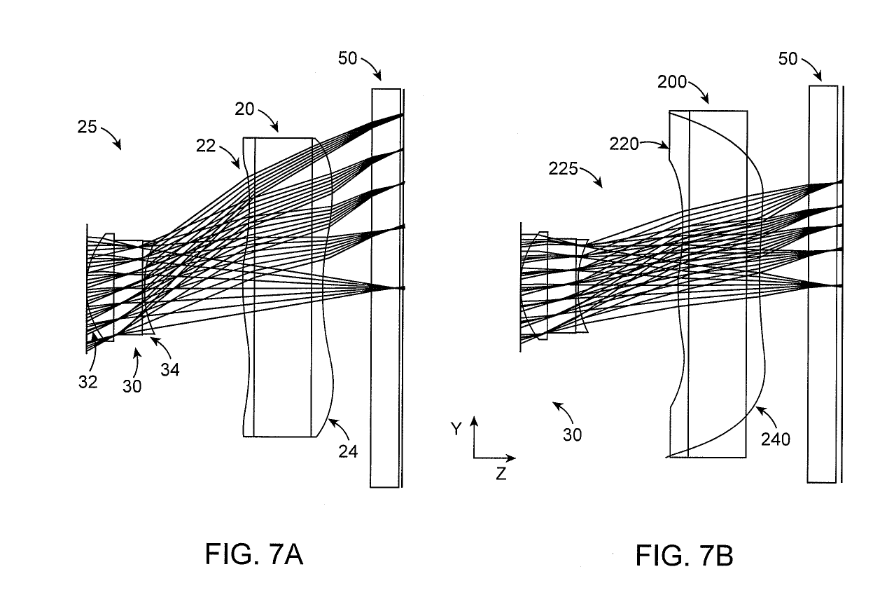

For example, as illustrated in FIG. 7A, a camera 25 may include a first lens 30, here a meniscus lens having a first convex surface 32 and a second concave surface 34, and a second lens 20 having opposing rotationally symmetric gull-wing surfaces, i.e., has both positive and negative curvatures across the lens surface, with a central region on a surface 22 being convex and a central region on a surface 24 being concave. Light output from the second lens 20 is imaged onto a detector 50, e.g., an array of sensing elements. As illustrated in FIG. 7B, a camera 225 may include the first lens 30, the detector 50, and a second lens 200 having opposing nonrotationally symmetric gull-wing surfaces, with a central region on a surface 220 being convex and a central region on a surface 240 being concave. As can be seen therein, the chief ray angle is smaller when using the nonrotationally symmetric lens 200. Although not illustrated, the detector 50 may includes an array of sensing elements protected by a cover glass and a microlens array on the cover glass.

The camera 225 may be integrated on a wafer level, e.g., at least two of the first lens 30, the second lens 200, and the detector 50 may be secured on a wafer level before being singulated. When, as in the particular embodiment illustrated in FIG. 7B, two of the elements have an xy cross-section closer to one another than other elements, these elements, e.g., the second lens 200 and the detector 50, may be secured together before one or both is singulated. Alternatively, the first lens 30 and the second lens 200 may be individually created on a wafer level and singulated before being secured together along the z-direction.

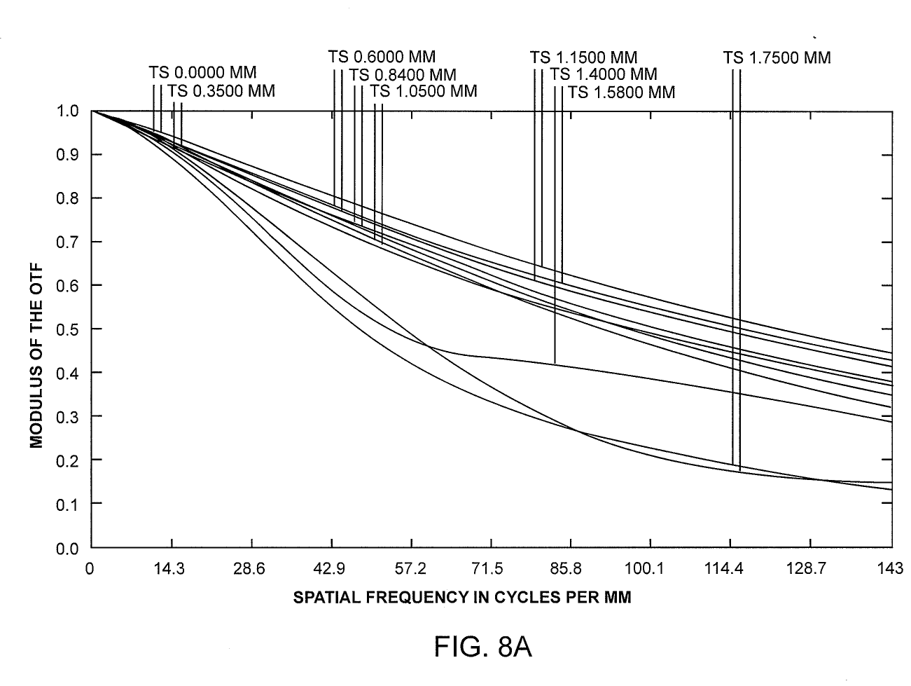

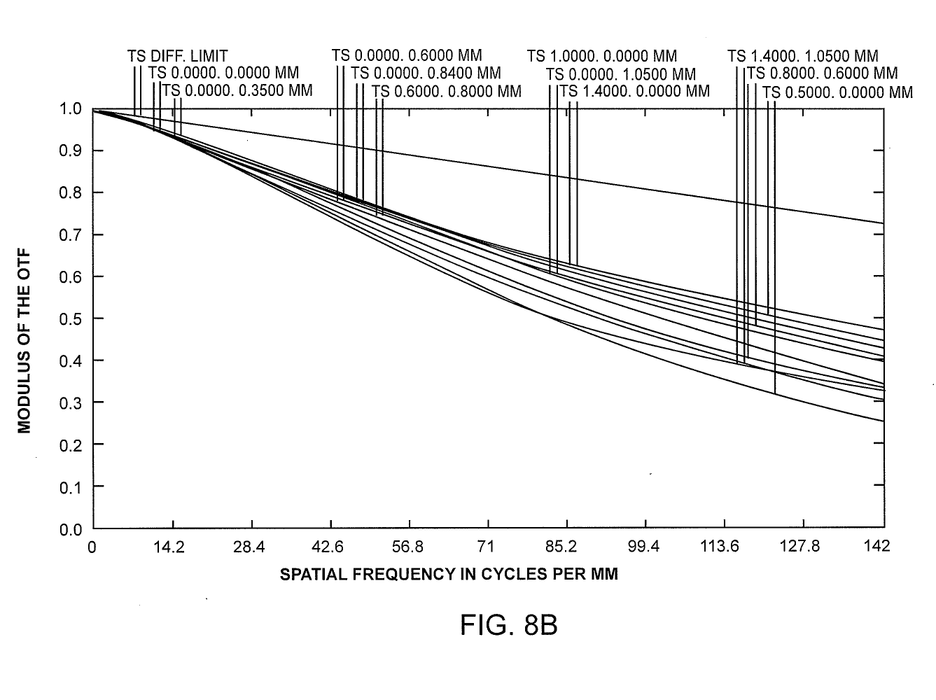

FIGS. 8A and 8B illustrate plots of the nominal mtf, over a wavelength range of 0.435 to 0.64 μm, of the camera 25 and the camera 225, respectively. As can be seen by comparing these plots, the mtf of the camera 225 is higher and more consistent than the mtf of the camera 25.

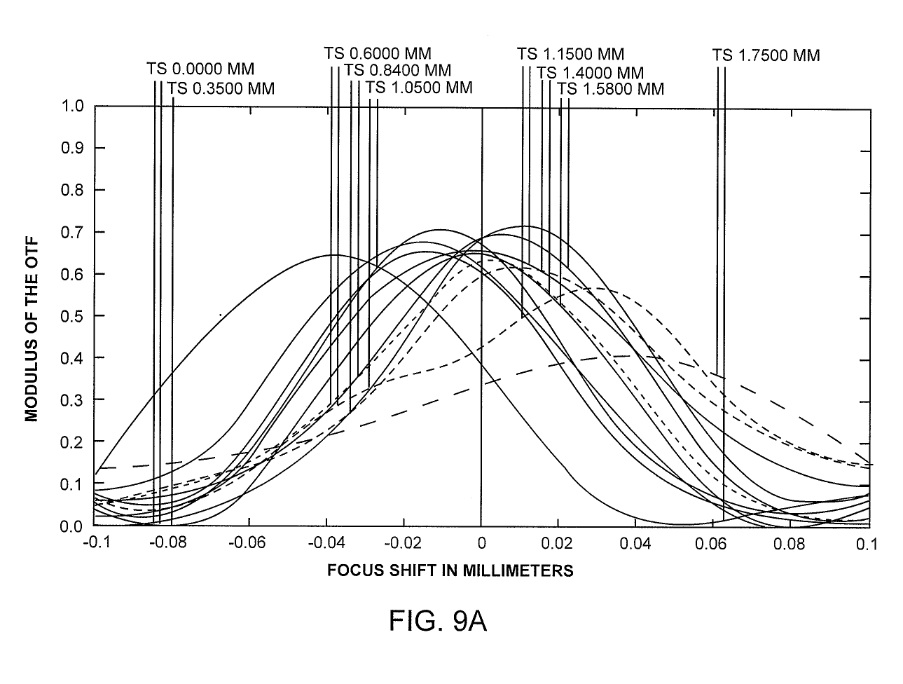

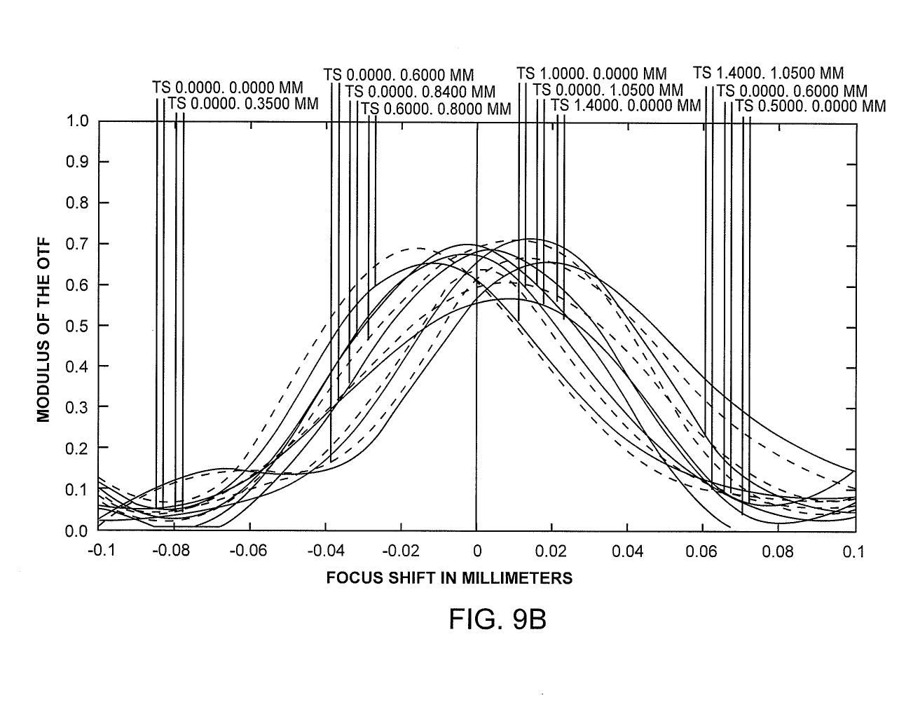

FIGS. 9A and 9B illustrate plots of the through focus mtf at 71 cycles/mm, over a wavelength range of 0.435 to 0.64 μm, of the camera 25 and the camera 225, respectively. As can be seen by comparing these plots, the through focus mtf of the camera 225 is higher and more consistent than the mtf of the camera 25.

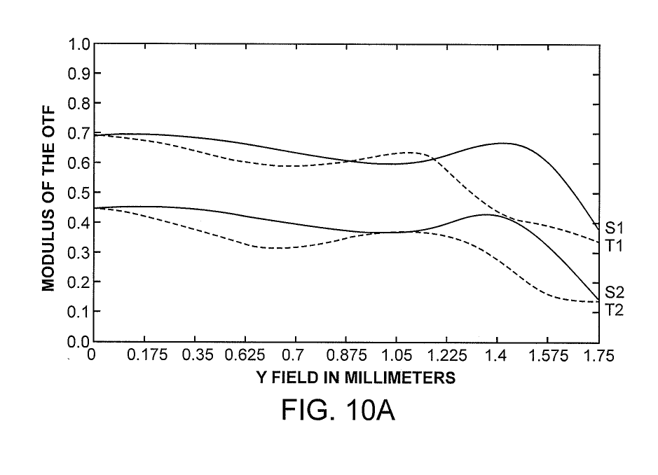

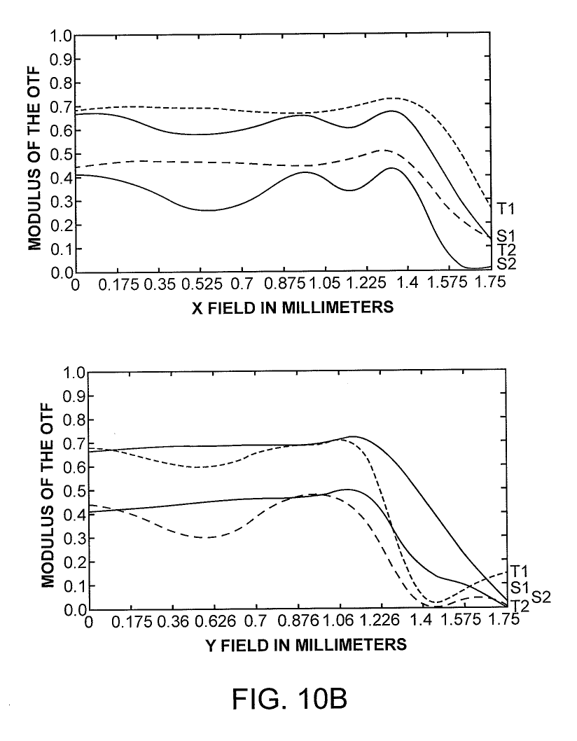

FIGS. 10A and 10B illustrate plots of MTF versus field of the camera 25 and the camera 225, respectively. These plots illustrate that most of the improvement realized using the nonrotationally symmetric lens 200 comes at the corners. In other words, the mtf in the X and Y directions for the camera 225 stays high until the edge of the image, and then drops quickly, showing that the system spontaneously gives up on performance beyond the used areas.

While the nonrotationally symmetric lens 200 illustrated above has opposing surfaces designed in accordance with nonrotationally symmetric designs, the above advantages may be realized by providing a nonrotationally symmetric surface on one of the surfaces of a second lens.

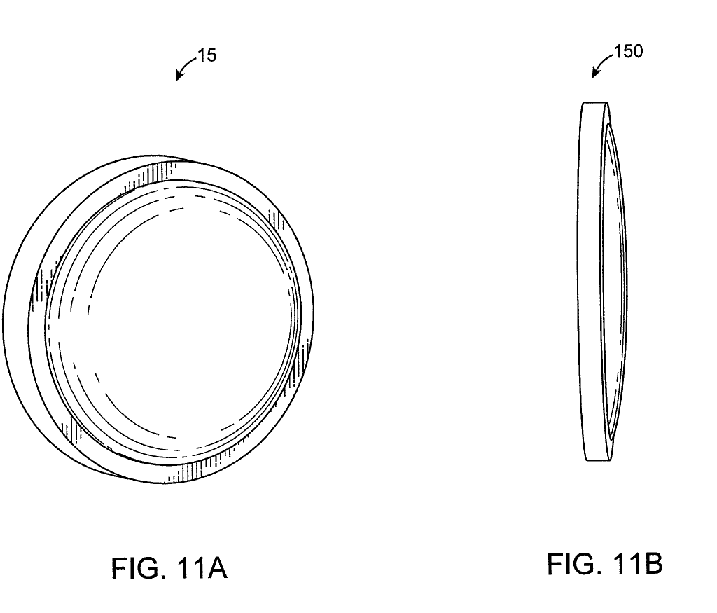

FIG. 11A illustrates a perspective view of a rotationally symmetric lens 15. FIG. 11B illustrates a perspective view of a nonrotationally symmetric lens 150 according to an embodiment in which Zernike polynomials Z17 and Z28 are used for the r² term in a conventional rotationally symmetric design and are optimized over a square plane. The nonrotationally symmetric lens 150 provides more power towards the edges thereof.

One particular application of using nonrotationally symmetric lenses is in the design of a singlet lens. Singlet lenses are widely employed due to their low cost, but the performance thereof is compromised.

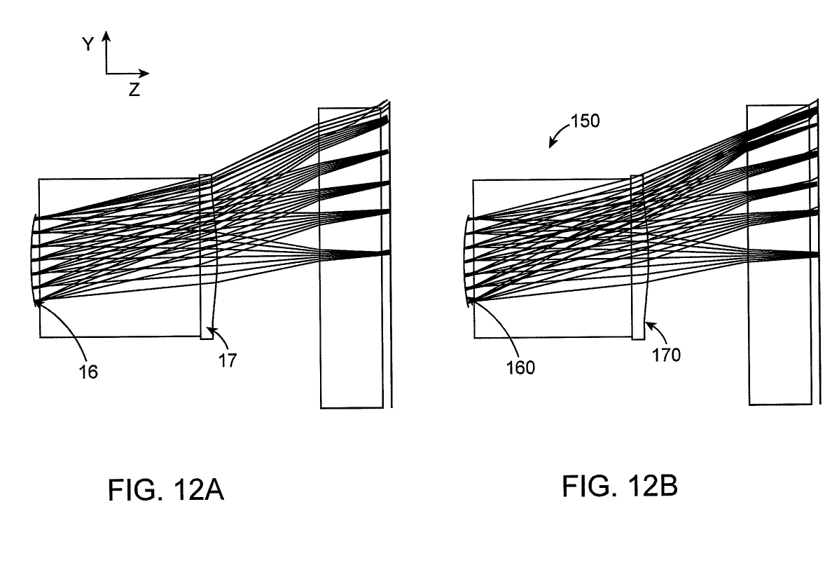

FIGS. 12A and 12B illustrate ray traces of light through the rotationally symmetric lens 15 and the Zernike polynomial lens 150, respectively. In the particular example of a singlet illustrated in FIG. 2A, the rotationally symmetric lens 15 is a double convex lens that includes a first convex surface 16 and a second convex surface 17. In the particular example of a singlet illustrated in FIG. 12B, the nonrotationally symmetric lens 150 is a double convex lens that includes a first convex surface 160 and a second convex surface 170. The design parameters of lenses 15 and 150 are the same, other than the use of radial polynomials for the design of the rotationally symmetric lens 15 and the use of Zernike polynomials for the design of the nonrotationally symmetric lens 150.

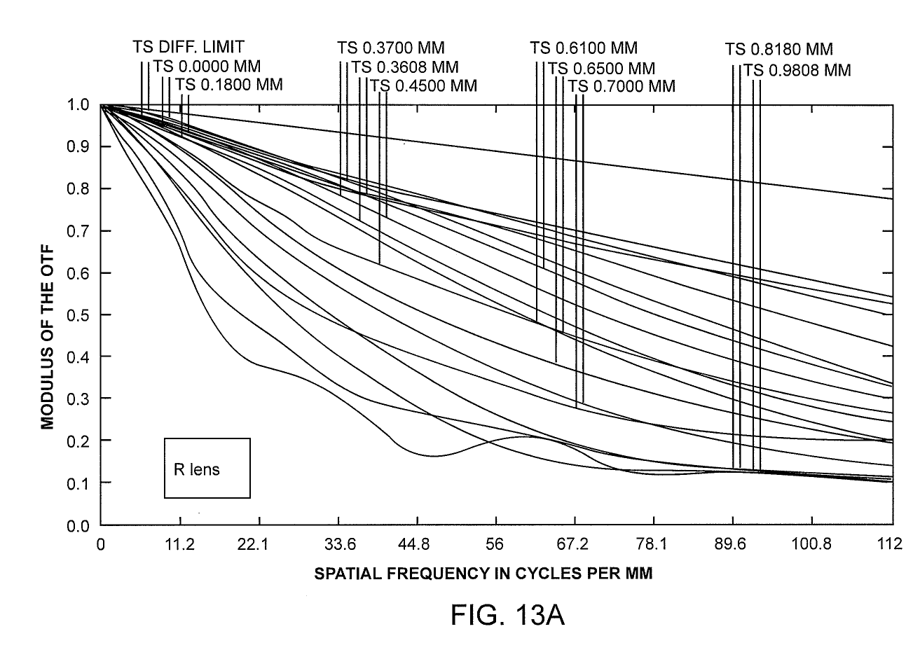

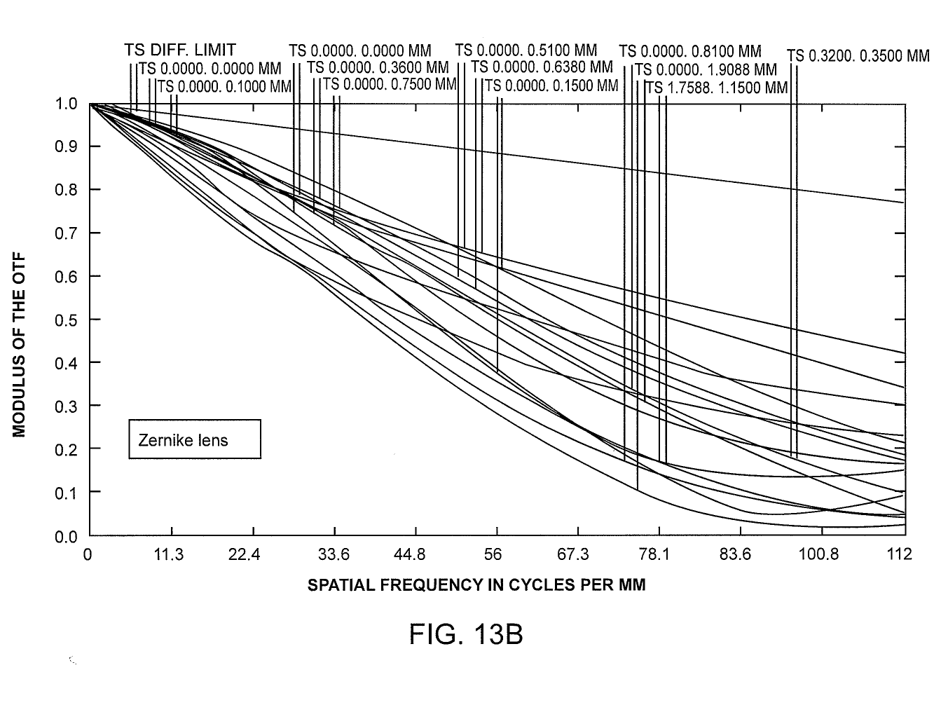

FIGS. 13A to 13B illustrate plots of the nominal modulus transfer function (mtf), i.e., contrast versus resolution, over a wavelength range of 0.435 to 0.64 μm, of the rotationally symmetric lens 15b and the nonrotationally symmetric lens 150, respectively. As can be seen by comparing the plots in FIGS. 13A and 13B, the mtf of the nonrotationally symmetric lens 150 is higher and more consistent than the mtf of the rotationally symmetric lens 15.

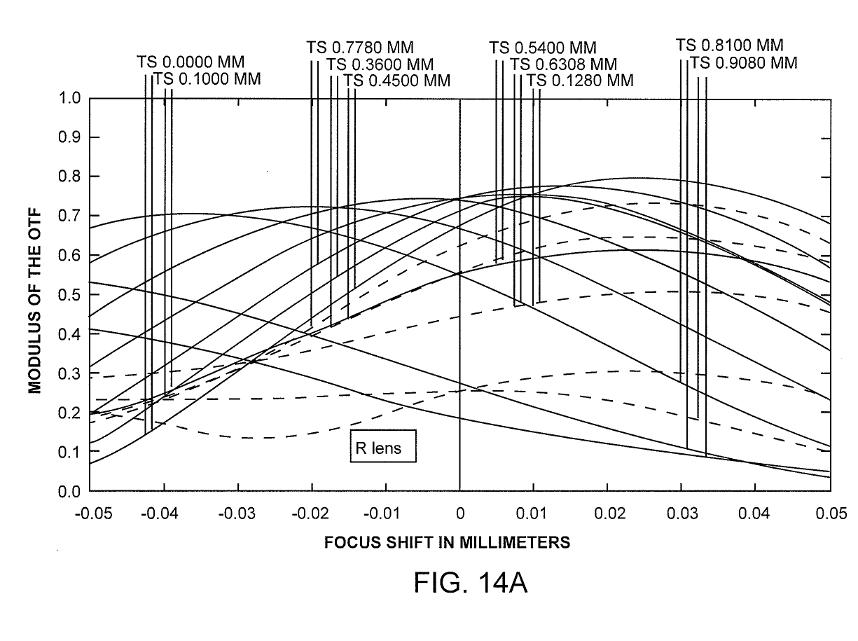

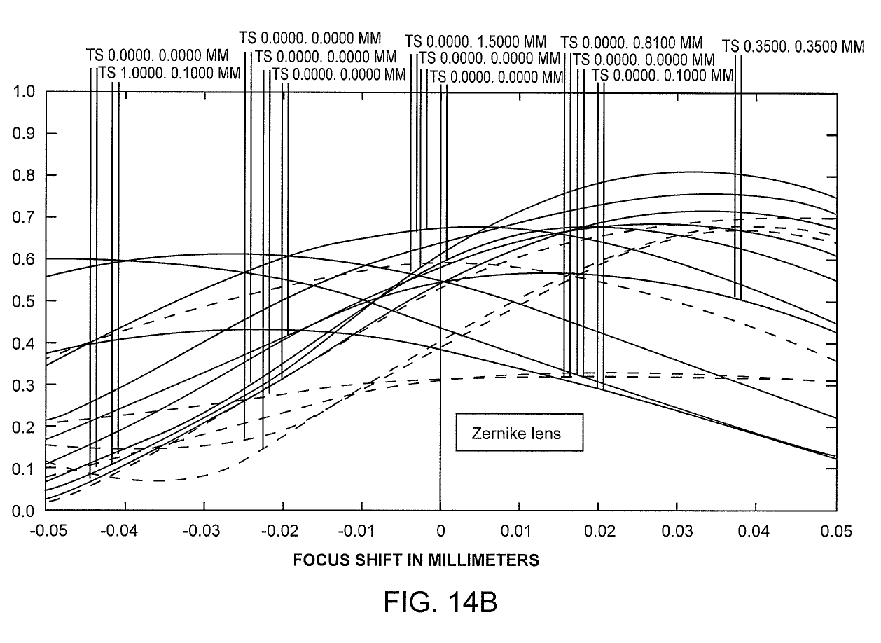

FIGS. 14A to 14B illustrate plots of the through focus mtf at 57 cycles/mm, i.e., contrast versus focus shift, over a wavelength range of 0.435 to 0.64 μm, of the rotationally symmetric lens 15 and the Zernike polynomial lens 150, respectively. As can be seen by comparing the plots in FIGS. 4A and 4B, the through focus mtf of the Zernike polynomial lens 150 is higher and more consistent than the through focus mtf of the rotationally symmetric lens 15.

Nonrotationally symmetric lenses may be tailored for other specific applications, i.e., other than generic imaging. For example, if the lens was to be used in a system for tracking motion, the nonrotationally symmetric lens may be optimized to provide a higher resolution along one axis. As another example, special effects may be realized by having the nonrotationally symmetric lens serve as an aperture. For example, the nonrotationally symmetric lens may serve as a vignetting aperture that purposely reduces brightness at a periphery of an image.

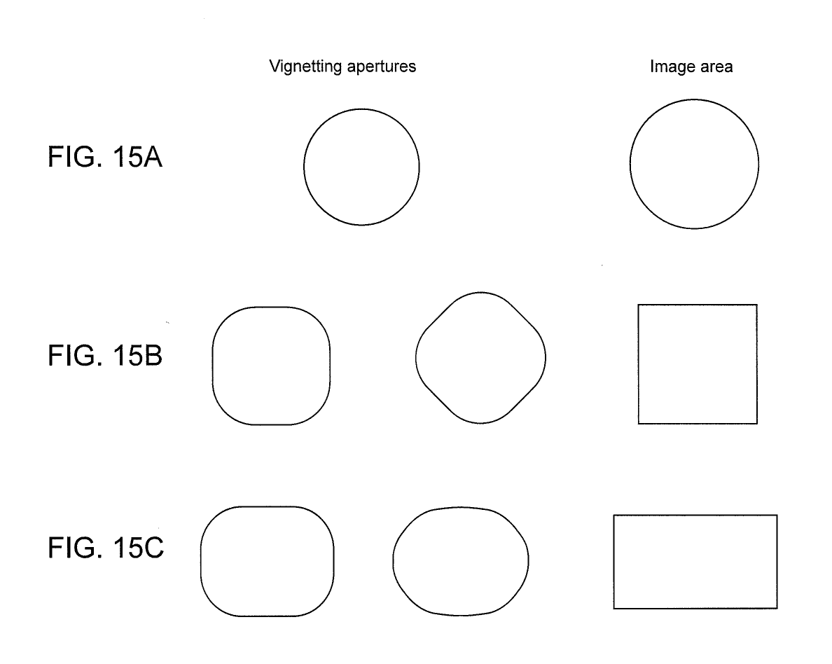

Examples of shapes of nonrotationally symmetric lens serving as vignetting apertures assuming a circular entrance pupil are illustrated in FIGS. 15A to 15C. In FIG. 15A, for a rotationally symmetric lens, a vignetting aperture will be circular. In contrast, when using nonrotationally symmetric lenses to match image planes, vignetting apertures may have more complex shapes and may be optimized with the nonrotationally symmetric lens. For example, in FIG. 15B, for a square image area, a nonrotationally symmetric lens may provide a square or diamond having rounded corners as an aperture. In FIG. 15C, for a rectangular image area, a nonrotationally symmetric lens may provide a rectangle or a hexagon having rounded corners as an aperture.

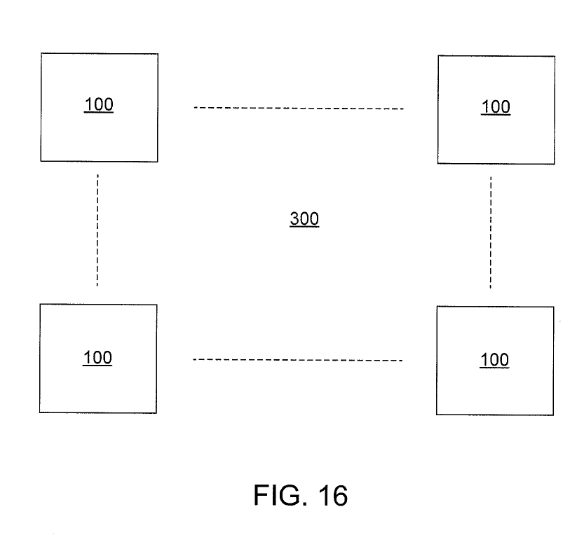

The use of nonrotationally symmetric lenses may also be advantageous when array of such lenses is to be formed. As can be seen in the solid model in FIG. 1B, the footprint of the last surface of the nonrotationally symmetric lens is not circular. Typically, there is a certain blend zone width that must exist around the edge of the lens. When the lens has a rectangular profile, as lens 100 does, then the lens 100 may more readily be packed into a rectangular array 300, as illustrated in FIG. 16, which may be advantageous when the imaging plane has a rectangular configuration. In other words, use of nonrotationally symmetric lens may allow matching of the footprint of the lens array to that of the imaging plane, i.e., a sensing element arrangement in the imaging plane. As such, other polynomials may be used to create an array of nonrotationally symmetric lenses having different footprints.

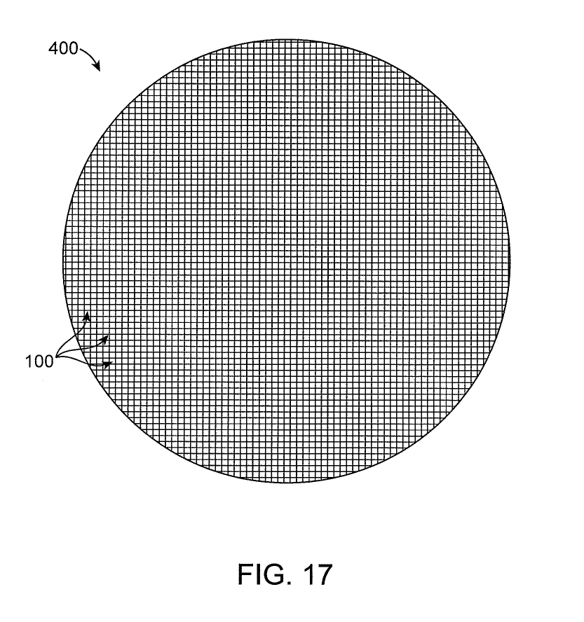

Further, as illustrated in FIG. 17, when the nonrotationally symmetric lenses have a non-circular profile, e.g., a rectangular profile, as lens 100 does, then the lens 100 may more readily be packed into a wafer 400, allowing more lenses 100 per wafer 400, reducing the cost of each die.

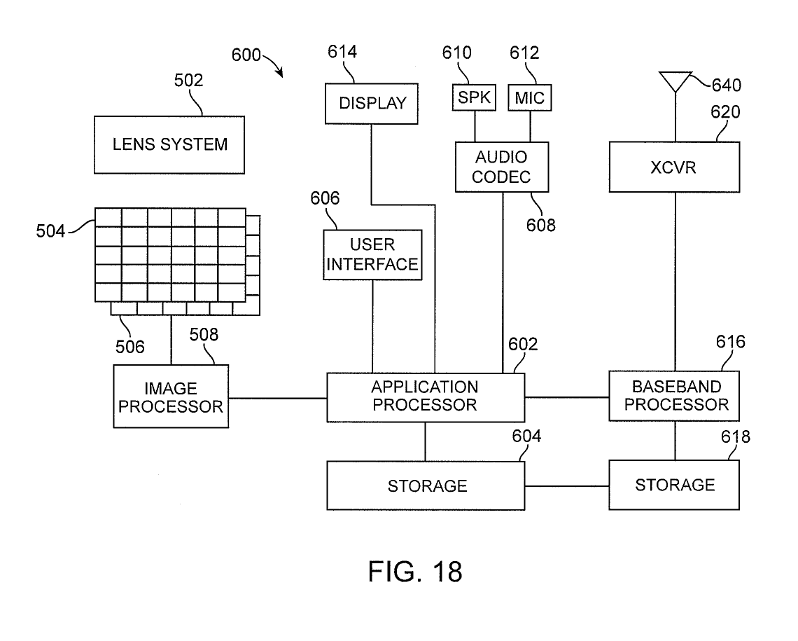

An example of a mobile communication device in which a lens system 502 including or only the nonrotationally symmetric lens, e.g., lens 100, 150 of FIGS. 1B and 11B, may be incorporated is shown in FIG. 18. In addition to the lens system 502, the mobile communication device further includes a color filter array (CFA) 504, an optical sensor array 506, and an image processor 508. The mobile communication device 600 of FIG. 14 further includes an application processor 602, which is coupled to the image processor 508. The application processor 602 may be further coupled to various other components, including storage 604, user interface 606, display 614, and audio codec 608. In one embodiment, it is the application processor 602 that provides most of the non-wireless communication functionality of the device 600. In performing its functions, the application processor 602 executes one or more programs (not shown) stored in storage 604. These programs may include an operating system, which is executed by application processor 602 to provide the basic functions required by the hardware and software components of the device 600. These programs may further include other programs (e.g. games, tools, social networking programs, utilities, navigation programs, browsing programs, etc.) that enable the application processor 602 to provide additional functionality. Storage 604 may store any type of program to enable the application processor 602 to provide any type of functionality. In addition to storing programs, the storage 604 may also be used by the application processor 602 to store temporary information/data that is used by the application processor 602 during program execution.

During operation, the application processor 602 interacts with the user interface 606 to receive input from a user. The user interface 606 may include, for example, a touch sensitive screen, a cursor control device, a keyboard/keypad (physical or virtual), and various other devices that allow the user to provide input. To provide visual output to the user, the application processor 602 is coupled to the display 614. Display 614 may be an LCD screen, an LED screen, an OLED screen, or any other type of display that allows the user to view visual output in the form of text, web pages, video, etc.

The application processor 602 may also be coupled to the audio codec 608 to enable the user to provide audio input to the device 600 and to enable the application processor to provide audio output to the user. The audio codec 608 receives analog audio input from the user through microphone 612 and transforms the analog audio input into digital audio signals that can be processed by the application processor 602. In addition, the codec receives digital audio signals from the application processor 602 and transforms them into analog audio signals that can be played by the speaker 610 to the user.

The application processor 602 may further be coupled to a baseband processor 616, which in turn is coupled to a second storage 618 and a transceiver 620. In one embodiment, the baseband processor 616 is responsible for performing most of the wireless communication functions of the mobile communication device 600. In doing so, the baseband processor 616 executes one or more programs (not shown) stored in the second storage 618. These programs may include an operating system (which may be the same or different operating system as that executed by the application processor 602), programs for processing incoming communication signals, program for processing outgoing communication signals, and various other programs. In addition to storing programs, the storage 618 may also be used by the baseband processor 616 to store temporary information/data that is used by the baseband processor 616 during program execution.

In processing wireless communication signals, the baseband processor 616 interacts with the transceiver 620. The transceiver 620 receives incoming wireless communication signals through antenna 640 and transforms them into digital signals that can be processed by the baseband processor 616. In addition, the transceiver 620 receives digital signals from the baseband processor 616 and transforms them into signals that can be sent out wirelessly through antenna 640.

In wireless communication device 600, the application processor 602 acts as the central interface for integrating the image processor 308 and the baseband processor 616 with the other components in the device 600. For example, the application processor 602 receives the image information processed by the image processor 308 and allows it to be displayed on display 614. The application processor 602 also allows the image information to be stored in storage 604. In addition, the application processor 602 receives digital communication signals from the baseband processor 616 and allows it to be sent to the speaker 610 to be played to the user. Furthermore, the application processor 602 allows audio input provided by the user through microphone 612 to be sent to the baseband processor 616 for further processing and subsequent transmission.

Use of a nonrotationally symmetric lens in accordance with embodiments in such wireless communication devices may allow imaging systems to be incorporated therein while not significantly increasing thickness and/or cost.

Exemplary embodiments have been disclosed herein, and although specific terms are employed, they are used and are to be interpreted in a generic and descriptive sense only and not for purpose of limitation. For example, while the above has discussed matching the non-rotationally symmetric lens to an image plane, the non-rotationally symmetric lens on may be matched to another non- rotationally symmetric element in an optical system, such as a non-rotationally symmetric pupil, e.g., an ellipse or a cloverleaf. Accordingly, it will be understood by those of ordinary skill in the art that various changes in form and details may be made without departing from the spirit and scope of the present invention as set forth in the following claims.

What is claimed is:

1. A singlet lens having opposing first and second surfaces, at least one surface being nonrotationally symmetric, the singlet lens substantially maintaining a ratio of magnification along orthogonal axes.

2. The singlet lens as claimed in claim 1, wherein both first and second surfaces are nonrotationally symmetric.

3. The singlet lens as claimed in claim 1, wherein the nonrotationally symmetric surface is an xy polynomial or a Zernike polynomial.

4. An imaging system, comprising:
a first optical surface adjacent an input plane;
a detector; and
a second optical surface between the first optical surface and the detector, the second optical surface being non-rotationally symmetric, wherein the first optical surface, the detector, and the second optical surface are linearly arranged.

5. The imaging system as claimed in claim 4, wherein the second optical surface is a closest optical surface to the detector.

6. The imaging system as claimed in claim 4, further comprising a third optical surface between the first optical surface and the second optical surface, the third optical surface being non-rotationally symmetric.

7. The imaging system as claimed in claim 6, wherein the third optical surface is opposite the second optical surface on a substrate.

8. The imaging system as claimed in claim 4, wherein at least two of the first optical surface, the detector, and the second optical surface are secured on a wafer level before being singulated.

9. The imaging system as claimed in claim 4, wherein the detector is a non-rotationally symmetric array of sensing elements and the second optical surface is optimized for the non-rotationally symmetric array.

10. The imaging system as claimed in claim 9, wherein the non-rotationally symmetric array is a rectangle.

11. The imaging system as claimed in claim 10, wherein the second optical surface is an xy polynomial or a Zernike polynomial.

12. The imaging system as claimed in claim 4, wherein the second optical surface is an xy polynomial or a Zernike polynomial.

13. The imaging system as claimed in claim 4, wherein the second optical surface is spaced from an aperture stop of the imaging system.

14. The imaging system as claimed in claim 4, wherein the second optical surface serves as a vignetting aperture for the imaging system.

15. A mobile handset including an imaging system as claimed in claim 4.

16. A method of creating a nonrotationally symmetric lens surface, comprising:
replacing a radial term in a conventional lens design with a nonrotationally symmetric polynomial;
optimizing a nonrotationally symmetric lens design; and
forming a plurality of nonrotationally symmetric lens surfaces on a wafer in accordance with the optimized nonrotationally symmetric lens design.

17. The method as claimed in claim 16, wherein the nonrotationally symmetric polynomial is an XY polynomial or a Zernike polynomial.

18. The method as claimed in claim 16, wherein forming includes replicating the plurality of nonrotationally symmetric lens surfaces on the wafer.

19. The method as claimed in claim 16, wherein optimizing includes matching the nonrotationally symmetric lens design to a nonrotationally symmetric element in a system into which the nonrotationally symmetric lens surface is to be incorporated.

20. The method as claimed in claim 19, further comprising, before separating the plurality of nonrotationlly symmetric lens surfaces from the wafer, securing a plurality of nonrotationally symmetric elements adjacent the nonrotationally symmetric lens surfaces.
